(19) United States
(12) Patent Application Publication
(10) Pub. No.: US 2008/0028399 A1
(43) Pub. Date: Jan. 31, 2008

(54) System and method for attributing to a corresponding virtual machine CPU utilization of a network driver domain based on observed communication through a virtualized interface

(76) Inventors: Diwaker Gupta, Fort Collins, CO (US); Ludmila Cherkasova, Fort Collins, CO (US); Robert D. Gardner, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/493,506

(22) Filed: Jul. 26, 2006

(51) Int. Cl. G06F 9/455

(52) U.S. Cl. 718/1

(57) ABSTRACT

A method comprises observing communication through a virtualized interface between at least one virtual machine (VM) and a driver domain. The method further comprises determining for each of the at least one VM, based on the observed communication through the virtualized interface, an amount of communication between the VM and the driver domain. In certain embodiments, the method further comprises determining for each of the at least one VM, based on the determined amount of communication between the VM and the driver domain, CPU utilization of the driver domain attributable to the VM. In certain embodiments, the driver domain comprises a network driver domain. In certain embodiments, the driver domain comprises an isolated network diver domain.

### CROSS-REFERENCE TO RELATED APPLICATIONS

This application is related to co-pending and commonly assigned U.S. patent application Ser. No. 11/070,674 filed Mar. 2, 2005 titled “SYSTEM AND METHOD FOR ATTRIBUTING TO A CORRESPONDING VIRTUAL MACHINE CPU USAGE OF AN ISOLATED DRIVER DOMAIN IN WHICH A SHARED RESOURCE'S DEVICE DRIVER RESIDES”, the disclosure of which is hereby incorporated herein by reference. This application is also related to concurrently filed and commonly assigned U.S. patent application Ser. No. ______ [Attorney Docket No. 200507008-1] titled “SYSTEM AND METHOD FOR ATTRIBUTING TO A CORRESPONDING VIRTUAL MACHINE CPU UTILIZATION OF A NETWORK DRIVER DOMAIN BASED ON WEIGHTED COMMUNICATION”, the disclosure of which is hereby incorporated herein by reference.

### FIELD OF THE INVENTION

The below description is related generally to monitoring of resource utilization, and more particularly to attributing CPU usage of an isolated network driver domain in which a shared network resource's device driver resides to a corresponding virtual machine that caused such CPU usage by the isolated network driver domain.

### DESCRIPTION OF RELATED ART

Traditionally, general-purpose operating systems assume that they have complete control of a system's physical resources. The operating system (“OS”) thus assumes responsibility for such system management as allocation of physical resources, communication, and management of external storage, as examples. Virtualization changes this assumption of sole responsibility by a single OS for management of the system. Similar to the way that a general-purpose OS presents the appearance to multiple applications that each has unrestricted access to a set of computing resources, a virtual machine manages a system's physical resources and presents them to one or more OSs, thus creating for each OS the illusion that it has full access to the physical resources that have been made visible to it.

The current trend toward virtualized computing resources and outsourced service delivery has caused interest to surge in Virtual Machine Monitors (VMMs) that enable diverse applications to run in isolated environments on a shared hardware platform. A VMM is a layer of software that runs on a host platform and provides an abstraction of a complete computer system to higher-level software. That is, a VMM, which may also be referred to as a “hypervisor,” is a software layer that virtualizes the available resources of a computer and multiplexes them among one or more guest OSs on the computer system. Many such VMMs are available in the art, such as the VMM known as VMware™ available from VMware, Inc. (see http://www.vmware.com). An abstraction created by VMM is called a virtual machine (VM). Accordingly, a VMM aids in subdividing the ample resources of a modern computer and creating the illusion of multiple virtual machines each running a separate OS instance.

Typically, VMMs are classified into two groups: 1) “Type I VMMs” that run directly on physical hardware and thus provide an abstraction that is identical to the hardware underneath the VMM, such as IBM's VM/370; and 2) “Type II VMMs” that run as an application on a host operating system, such as user-mode Linux. Type I and Type II machines are available in the art. For instance, VMWare, Inc. provides both types of VMMs. In a traditional Type I VMM, the exposed virtual hardware functionality is identical to the underlying machine. This “full virtualization” has the main benefit of allowing unmodified OSs to be hosted. However, support for full virtualization was never a part of prevalent IA-32 (e.g., x86) architecture, and the efficient virtualization is difficult, i.e., it can be only achieved at the cost of increased complexity and reduced performance.

Several aspects of virtualization make it difficult or slow for a VMM to provide an interface that is identical to the physical hardware. For instance, some architectures include instructions whose behavior depends on whether the CPU is running in privileged or user mode (sensitive instructions), yet which can execute in user mode without causing a trap to the VMM. Virtualizing these sensitive-but-unprivileged instructions generally requires binary instrumentation, which adds significant complexity and may add significant overhead. For example, VMware's ESX Server dynamically rewrites portions of the hosted machine code to insert traps wherever VMM intervention might be required. In addition, emulating I/O devices at the low-level hardware interface (e.g. memory-mapped I/O) causes execution to switch frequently between the guest OS accessing the device and the VMM code emulating the device. To avoid the overhead associated with emulating a low-level device interface, most VMMs encourage or require the user to run a modified version of the guest OS. For example, the VAX VMM security kernel, VMware Workstation's guest tools add special drivers in the guest OS to accelerate the virtualization of some devices.

A new virtualization technique, called paravirtualization, has been recently introduced, that avoids the drawbacks of full virtualization by presenting a virtual model machine abstraction that is similar but not identical to the underlying hardware. This technique provides improved performance, but it also requires modification to the guest OSs, i.e. the commodity system needs to be ported to a paravirtualized environment. Xen™ is an example of a known VMM for x86 based on the paravirtualization technique, which supports execution of multiple guest OSs and that does not require changes to the application binaries interfaces (ABI), and hence no modifications are required to guest applications. Xen is an open source VMM, and the latest stable release of Xen is version 3.0.1, which is available as of the filing of this application at http://www.cl.cam.ac.uk/Research/SRG/netos/xen/downloads.html. In certain virtualization techniques, device drivers for shared resources are located in a privileged management domain, and thus to access those shared resources the virtual machines communicate with such privileged management domain. Further, in certain virtualization techniques, device drivers for shared resources are located in an isolated driver domain to improve dependability, maintainability, and manageability of the shared resources.

For various reasons, including without limitation management of resource allocation, it is often desirable to monitor the CPU utilization that is attributable to each of the virtual machines (VMs) that may be implemented on a system. Traditional monitoring techniques report the amount of CPU allocated by the scheduler for execution of a particular VM over time. However, this method often fails to reveal the “true” usage of the CPU that is attributable to different VMs. Thus, a desire exists for a system and method for accurately determining CPU utilization that is attributable to VMs on a system.

### BRIEF DESCRIPTION OF THE DRAWINGS

FIG. 1 shows an exemplary system according to an embodiment of the present invention;

FIG. 2 shows an exemplary operational flow according to one embodiment of the present invention;

FIG. 3 shows an exemplary operational flow according to another embodiment of the present invention;

FIG. 4 shows an exemplary operational flow according to another embodiment of the present invention;

FIG. 5 shows an exemplary system according to one embodiment of the present invention;

FIG. 6 shows a specific exemplary virtualization architecture implementing an embodiment of the present invention; and

FIG. 7 shows an exemplary I/O processing path in the exemplary virtualization architecture of FIG. 6 according to one embodiment of the present invention.

### DETAILED DESCRIPTION

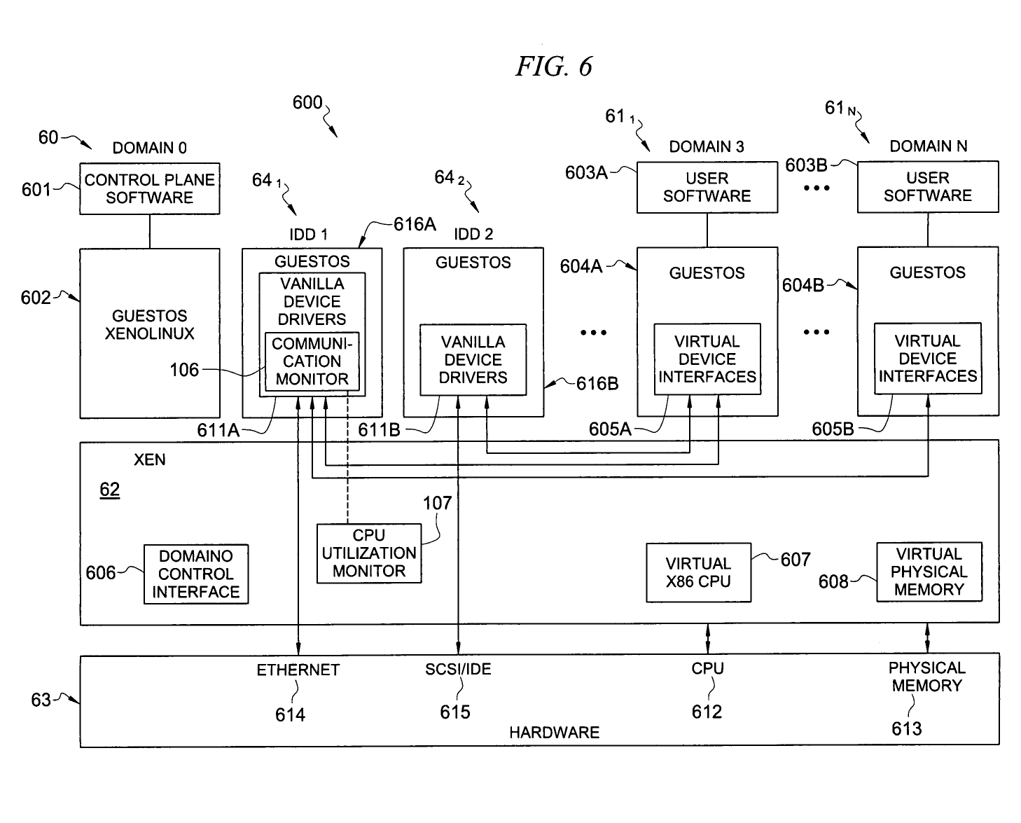

As described above, virtualization enables resources to be shared between a plurality of VMs. A VMM is a software layer that virtualizes the available resources of a computer system and multiplexes them among one or more guest OSs on the computer system. As used herein, the term guest operating system refers to one of the OSs that the VMM can host, and the term domain refers to a running virtual machine within which a guest OS executes. Thus, the terms virtual machine (VM) and domain are used interchangeably herein. A privileged management domain refers to a domain that manages the creation and/or termination of other guest domains and may manage other parameters, such as CPU scheduling parameters, resource allocation policies, etc. A driver domain refers to a domain in which a device driver for one or more shared resources resides. An isolated driver domain refers to a domain in which a device driver is placed such that failure of the device driver does not interrupt any other domains in the system. An exemplary implementation of an isolated driver domain is described further herein with FIGS. 6-7. The VMM may be referred to as a hypervisor because it operates at a higher privilege level than the supervisor code of the guest OSs that it hosts. Thus, the terms VMM and hypervisor are used interchangeably herein.

For various reasons, including without limitation management of resource allocation, it is often desirable to monitor the CPU utilization that is attributable to each of the VMs that may be implemented on a system. Traditional monitoring systems typically report the amount of CPU allocated by the scheduler for execution of a particular VM over time. However, this method often fails to reveal the “true” usage of the CPU by different VMs. For instance, in certain virtualization techniques, device drivers for shared resources are located in isolated driver domains, and thus to access those shared resources the VMs communicate with such isolated driver domains. Accordingly, the isolated driver domains use the CPU in processing the access requests received from the VMs. The CPU utilization of the isolated driver domains in servicing the requests of each VM (requesting to access a resource) are not attributed to the corresponding VMs in the traditional technique of monitoring VM CPU utilization (i.e., as those techniques report the amount of CPU allocated to a VM by the scheduler). Thus, the full CPU utilization of the VMs, including the corresponding isolated driver domain CPU utilization, is not determined.

For example, virtualization of input/output (I/O) devices results in an I/O model where the data transfer process involves additional system components, such as an isolated driver domain in which device drivers for the I/O resources reside. Hence, the CPU usage when the isolated driver domain handles the I/O data on behalf of a particular VM should be charged to the corresponding VM. However, simply monitoring the CPU utilization allocated by the scheduler to the corresponding VM fails to account for the CPU utilization of the isolated driver domain in handling the I/O data on behalf of such corresponding VM. Thus, the traditional technique of determining CPU utilization of each VM does not fully capture the CPU utilization attributable to a VM, as it fails to account for the corresponding isolated driver domain CPU utilization that is performed for each VM.

Embodiments of the present invention provide a system and method for monitoring communication through a virtualized interface between VMs and isolated network driver domains. In general, a network driver domain refers to a domain in which a device driver for accessing a communication network resides. In certain embodiments, such monitored communication may be used for attributing to corresponding VMs CPU utilization of an isolated network driver domain in which a shared communication network's device driver resides. For instance, certain embodiments are provided herein in which a virtualized system has an isolated network driver domain that includes a device driver that enables access to shared network resources (e.g., I/O resources). Communications through a virtualized interface between a VM and the isolated network driver domain (e.g., the device driver included in the isolated network driver domain) are observed and, based on such observed communications, an amount of communication may be determined. For instance, a number of communication units (e.g., network packets) may be observed, and, in certain embodiments, the observed number of communication units (e.g., network packets) may be used to determine CPU utilization of the isolated network driver domain that is attributable to the VM. Thus, certain embodiments provided herein monitor communications through a virtualized interface between a VM and an isolated network driver domain, and based on such communications (e.g., based an observed amount of communication units, such as network packets at the virtualized interface) determine an amount of CPU utilization of the isolated network driver domain that is attributable to the VM.

Certain techniques for observing communication between a VM and an isolated driver domain and attributing to the VM corresponding CPU usage of the isolated driver domain are described in co-pending and commonly assigned U.S. patent application Ser. No. 11/070,674 filed Mar. 2, 2005 titled “SYSTEM AND METHOD FOR ATTRIBUTING TO A CORRESPONDING VIRTUAL MACHINE CPU USAGE OF AN ISOLATED DRIVER DOMAIN IN WHICH A SHARED RESOURCE'S DEVICE DRIVER RESIDES”, the disclosure of which is hereby incorporated herein by reference. Certain embodiments presented therein attribute such CPU usage of an isolated driver domain to a corresponding VM based on a memory page exchange count. While such usage of memory page exchange count may provide a good estimate, it may introduce some inaccuracy due, for example, to the specific memory page exchange procedure employed by the VMM. For instance, often the VMM commercially known as Xen-3TM opportunistically performs additional memory page exchanges in order to keep a sufficient pool of memory pages in an isolated driver domain. Due to Direct Memory Access (DMA), some of the I/O data from a VM can be directly written to memory in an isolated driver domain (“IDD”).

Certain embodiments of the present invention provide a more accurate technique for observing communication between a VM and an isolated driver domain (“IDD”) by observing the amount of communication flowing through a virtualized interface between such VM and the IDD. For example, certain embodiments are particularly applicable to an isolated network driver domain (a “net-IDD”) that comprises a device driver for accessing a communication network. For instance, in certain embodiments a specific number of communication units (e.g., network packets) communicated between a VM and the net-IDD through the virtualized interface can be counted, which may provide a more accurate measurement of the communication between the VM and the net-IDD than observing memory page exchanges.

In certain embodiments of the present invention, the monitored communications are requests from a VM requesting access to shared resources, such as I/O resources. The I/O resources may be communication network resources, disk, etc. Certain embodiments are particularly advantageous for observing communication between a VM and a net-IDD in performing communication network I/O, and thus the amount of CPU usage by the net-IDD for such communication network I/O that is attributable to the corresponding VM can be determined.

In certain embodiments, the monitored communications flow through a virtualized interface. For instance, in certain embodiments, a virtualized interface for a net-IDD comprises a virtualized front-end interface residing in a VM and a virtualized back-end interface residing in the net-IDD. A communication monitor may be implemented within the virtualized back-end interface for observing communications through such virtualized interface. In a paravirtualized environment, requests for accessing shared resources may be made from the VM to the VMM or to the IDD directly. For example, the guest OSs may be adapted to include a virtual device interface for accessing certain resources via the VMM. In other implementations of virtualization, such as in a fully-virtualized environment, the VM may not make a request to the VMM or the IDD (e.g., the guest OS may not be adapted to communicate with the VMM) but instead the VMM may intercept requests by the VM to access resources and the VMM may forward the requests (e.g., through a virtualized interface) to the appropriate IDD. Such intercepted communications are encompassed by the communications between the VM and IDD described herein, and may be used in certain embodiments for determining the amount of CPU utilization by the IDD that is attributable to the corresponding VM. Thus, certain embodiments of the present invention are applicable for determining the amount of CPU utilization of an IDD that is attributable to each VM implemented on the system, and the embodiments described herein may be employed for any type of virtualization framework, including without limitation full virtualization and paravirtualization frameworks.

In certain implementations, a plurality of VMs (or “domains”) may be implemented on a system, and the VMM may multiplex access to shared resources, such as I/O resources, among the VMs. Further, in certain implementations, device drivers for at least some of the shared resources reside in one or more driver domains, and thus the corresponding driver domain is accessed for accessing those shared resources. In certain embodiments, the driver domains are implemented as IDDs, which isolate failure of a given driver from causing a failure of any other domains (other driver domains, guest domains (e.g., VMs), etc.). That is, as described further below, device drivers are often responsible for failures in an OS, and thus, isolating those device drivers in separate domains that are each dedicated to a given device driver may be desirable for isolating failures. Embodiments of the present invention provide a system and method for determining an amount of communication that flows through a virtualized interface between VMs and a network driver domain (e.g., net-IDD), and certain embodiments use such determined amount of communication for attributing CPU utilization of the network driver domain (e.g., net-IDD) in which the network device drivers reside to the appropriate VMs (e.g., attribute the network driver domain's CPU utilization to the corresponding VMs that caused the network driver domain's CPU utilization). More specifically, certain embodiments provided herein monitor communications through a virtualized interface between each of the VMs and the network driver domain in which the network device drivers reside, and, based on such communications, determine an amount of CPU utilization of the network driver domain that is attributable to each of the VMs. Thus, the appropriate amount of the network driver domain's CPU utilization that is attributable to servicing requests from a given VM is attributed to such given VM. For instance, if the network driver domain utilizes the CPU to process a request from a first VM for accessing a communication network, this CPU utilization of the network driver is attributed to the first VM; and if the network driver domain utilizes the CPU to process a request from a second VM for accessing the communication network, this CPU utilization of the network driver domain is attributed to the second VM.

Further, embodiments of the present invention may be employed for various types of virtualization architectures. Exemplary implementations are described further herein, with reference to FIGS. 6 and 7, in which device drivers that enable access to certain resources (e.g., I/O resources, such as a communication network) are placed in an isolated driver domain. Examples of virtualization architectures in which the device drivers are placed in an IDD include those described by K. Fraser et al. in “Reconstructing I/O”, Tech. Report, UCAM-CL-TR-596, August 2004. The concepts presented herein may be employed for other virtualization architectures, as well.

In certain embodiments, the amount of CPU utilization that is scheduled for a VM is determined, and the amount of CPU utilization of a network driver domain in which a shared communication network's device driver resides that is attributable to such VM is determined. The scheduled CPU utilization of the VM and the determined CPU utilization of the network driver domain that is attributable to the VM are then summed to compute the total CPU utilization of the VM.

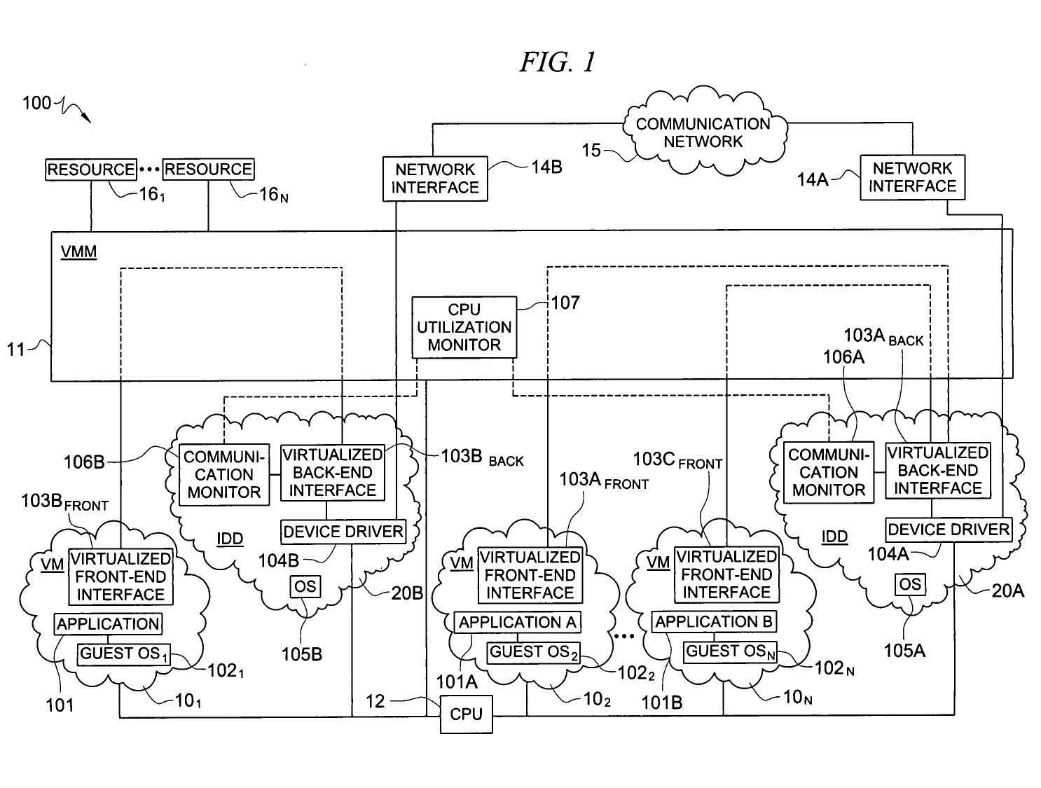

Turning to FIG. 1, an exemplary embodiment of the present invention is shown. As shown, computer system 100 has any number “N” of VMs or “domains” 10₁, 10₂, . . . , 10_{N} implemented thereon (referred to collectively as VMs 10). Such virtualization may be achieved utilizing any suitable technique now known or later discovered. Within each VM 10, a guest OS is executing, such as guest OS₁, 102₁ in VM 10₁, guest OS₂ 102₂ in VM 10₂, and guest OS_{N} 102_{N} in VM 10_{N}. Further, one or more applications may be executing within each VM 10, such as application C 101C in VM 10₁, application A 101A in VM 10₂, and application B 101B in VM 10_{N}. VMM 11 is implemented, which is a software layer that virtualizes the available resources of computer system 100 and multiplexes them among the various VMs 10 (e.g., the various guest OSs) on the computer system.

System 100 further includes CPU 12, and various shared resources of which VMM 11 manages access by the various VMs 10. The system's shared resources include I/O resources, such as network interfaces 14A and 14B (e.g., any of a variety of different network interface cards (NICs) and/or adapters), which enables system 100 to interface to communication network 15 (which may be a local area network (LAN), the Internet or other Wide Area Network (WAN), an intranet, a wireless network, telephony network, any combination of the aforementioned networks, and/or any other communication network now known or later developed within the networking arts which permits two or more computers to communicate with each other). The shared resources may include any number of other resources 16₁, . . . , 16_{N} to which VMM 11 manages access of the VMs 10, examples of which include without limitation memory (e.g., RAM) and block data storage (e.g., disks).

As described further herein, device drivers for certain ones of the shared resources are placed in driver domains 20 (such as driver domains 20A-20B). In this example, each of the device drivers is arranged in an isolated driver domain 20. More specifically, device driver 104A for supporting access to network interface 14A is arranged in net-IDD 20A, which also includes an OS 105A. Device driver 104B for supporting access to network interface 14B is arranged in net-IDD 20B, which also includes an OS 105B. Other device drivers for supporting access to other system resources, such as resources 16₁, . . . , 16_{N}, may likewise be arranged in other IDDs, which are not shown in FIG. 1 for simplicity. Thus, any number “N” of device drivers may be isolated in separate driver domains in this manner, thus resulting in any number “N” of IDDs 20.

The VMs 10 communicate through a virtualized interface to the appropriate network driver domain 20 for accessing a given shared resource (e.g., a shared network device driver), as described further herein. In the example shown in FIG. 1, VM 10₁ communicates through a virtualized interface with device driver 104B of net-IDD 20B for accessing network interface 1 4B. Similarly, each of VMs 10₂ and 10_{N} communicates through a virtualized interface with device driver 104A for accessing network interface 14A. Such virtualized interface may be implemented in any suitable manner. In the example shown in FIG. 1, the virtualized interfaces for supporting communication between the VMs and the net-IDDs comprise a front-end interface and a back-end interface. For instance, in the example shown in FIG. 1, the virtualized interface for supporting communication between VM 10₁ and device driver 104B of net-IDD 20B comprises a back-end interface 103B_{back} implemented in net-IDD 20B and a front-end interface 103B_{front} implemented in VM 10₁. Similarly, in the example shown in FIG. 1, net-IDD 20A implements a back-end interface 103A_{back} for supporting communication between VMs 10₂ and 10_{N} and device driver 104A of net-IDD 20A. VM 10₂ comprises a front-end interface 103A_{front}, and VM 10_{N} comprises a front-end interface 103C_{front}. Exemplary implementations of the virtualized interfaces (e.g., front-end and back-end interfaces) are described further herein. Of course, while VM 10₁ is shown as accessing network interface 14B via net-IDD 20B by communicating through the virtualized interface comprising front-end virtual interface 103B_{front} and back-end virtual interface 103B_{back}, in other instances VM 10₁ may access other system resources via their respective IDDs by communicating through the corresponding virtualized interfaces, such as accessing network interface 14A via net-IDD 20A by communicating through the back-end virtual interface 103A_{back}. Similarly, while VM 10₂ and VM 10_{N} are shown as accessing network interface 14A via net-IDD 20A by communicating through their respective virtualized interfaces, in other instances VMs 10₂ and/or 10_{N} may access other system resources via their respective IDDs by communicating through the corresponding virtualized interfaces.

As can be seen in FIG. 1, all communication between a VM and a device driver of an IDD flows through the corresponding virtualized interface. For instance, in the example of FIG. 1, all communication between VMs and net-IDD 20A flows through the back-end virtual interface 103A_{back}, and all communication between VMs and net-IDD 20B flows through the back-end virtual interface 103B_{back}. Thus, an accurate measurement of the amount of communication between a VM and a net-IDD can be determined through observing the flow of communication through such virtualized interfaces (e.g., through the net-IDD's respective back-end virtual interface). Thus, in the exemplary embodiment of FIG. 1, a communication monitor 106A is employed for monitoring communication through the virtualized back-end interface 103A_{back}, and a communication monitor 106B is employed for monitoring communication through virtualized back-end interface 103B_{back}. Of course, a communication monitor need not be implemented for observing the virtualized interface of every IDD of a system, if not so desired.

Each communication monitor 106A-106B may, for example, count the number of communication units flowing between any VM and the corresponding net-IDD. A communication unit generally refers to a unit of data that is employed for communication between a VM and a given IDD. For instance, communication monitor 106A may count the number of network packets flowing through virtualized back-end interface 103A_{back} between VM 10₂ and net-IDD 20A; and communication monitor 106A may likewise count the number of network packets flowing through virtualized back-end interface 103A_{back} between VM 10_{N} and net-IDD 20A.

In certain embodiments, the amount of observed communication through a virtualized interface between a VM and a net-IDD may be used for attributing a corresponding amount of CPU utilization of the net-IDD to the VM. For instance, in the example shown in FIG. 1, a CPU utilization monitor 107 is shown, which receives from communication monitor 106A and/or 106B the determined amount of communication flowing through virtualized back-end interfaces 103A_{back} and/or 103B_{back} for each of the VMs 10, and CPU utilization monitor 107 determines based on such amount of communication an amount of CPU utilization of net-IDDs 20A and/or 20B to be attributed to each of the VMs 10. For example, CPU utilization monitor 107 may receive from communication monitor 106A a count of network packets communicated through virtualized back-end interface 103A_{back} between VM 10₂ and net-IDD 20A, and CPU utilization monitor 107 may also receive a count of network packets communicated through virtualized back-end interface 103A_{back} between VM 10_{N} and net-IDD 20A. Based at least in part on the number of network packets counted for each VM 10₂ and 10_{N}, CPU utilization monitor 107 may determine a corresponding amount of CPU utilization by the net-IDD 20A that is attributable to each of such VMs 10₂ and 10_{N}. CPU utilization monitor 107 may also monitor an amount of CPU utilization directly used by each of the VMs, and by summing a VM's respective direct usage with the net-IDD's usage attributed to the VM, a total CPU utilization of the VM may be determined by the CPU utilization monitor 107, in certain embodiments.

Communication monitors 106A and/or 106B and CPU utilization monitor 107 may be software programs stored to a computer-readable medium (e.g., memory, hard disk, optical disc, magnetic disk, or any other data storage device now known or later developed) and executing on a processor-based device, such as a personal computer (PC), laptop computer, server computer, etc. Of course, the functionality of the communication monitors and/or CPU utilization monitor may be implemented in software, hardware, firmware, or any combination thereof. Thus, the communication monitors and/or CPU utilization monitor may be employed as any type of evaluation logic, whether software, hardware, firmware, or any combination thereof.

As described above, VMM 11 is generally a software layer that is commonly implemented in virtualization architectures, which virtualizes the available resources of computer system 100 and multiplexes them among the various VMs 10. Thus, to access certain resources, the VMs 10 communicate with the VMM 11 (e.g., either directly, as in a paravirtualized system, or via the VMM intercepting communication of the VMs, as in many fully-virtualized systems). In certain embodiments, while communications between may be conducted somewhat directly between a virtualized back-end and front-end interfaces, the VMM 11 may be involved in setting up those connections and helping to provide additional communication means (e.g., special calls between the IDD and VMs). That is, in certain implementations, the system is paravirtualized, in which the guest OS of each VM 10 is adapted in some manner to communicate via VMM with an IDD (e.g., IDD 20A of FIG. 1). For example, each of VM 10 may communicate through the respective virtualized back-end interface of an IDD (e.g., back-end interfaces 103A_{back} and/or 103B_{back} of FIG. 1). A more specific example of a paravirtualized system is described below with FIGS. 6-7. In other implementations, the guest OSs may not be so adapted, but instead the VMM 11 may act to intercept certain resource accesses attempted by the guest OSs, wherein the intercepted accesses are directed by the VMM 11 through the appropriate virtualized interface of an IDD; in which case, embodiments of the present invention may be employed to monitor the intercepted communications flowing through the virtualized interfaces just as the communications from a paravirtualized guest OS and the IDD may be monitored.

As also mentioned above, it is often desirable to measure resource utilization by the VMs 10. Available memory per VM 10 is typically statically allocated during the deployment stage and thus can be directly accounted for. Network and storage bandwidth usage can also be accounted by directly observing the amount of traffic transferred in/out of the particular VM. However, measuring the CPU usage by a particular VM 10 is not a straightforward task. VMM 11 often includes a scheduler that schedules CPU utilization for each of the VMs 10. As described above, however, monitoring the CPU utilization scheduled for each VM 10 often fails to fully account for all CPU utilization that should be attributed to each VM 10 because it fails to account for the CPU utilization of the driver domains 20 in servicing the corresponding resource access requests of each VM 10.

Accordingly, embodiments of the present invention may be used for implementing a CPU utilization monitor 107 that determines, for each of the VMs 10, a corresponding amount of CPU utilization of a network driver domain 20 that is attributable to such VM 10. More specifically, according to an embodiment of the present invention, CPU utilization monitor 107 may receive a determined amount of communication through a virtualized interface between a VM and a net-IDD (e.g., from a communication monitor, such as communication monitor 106A) and may determine from such amount of communication an amount of CPU utilization of the network driver domains 20 that is attributable to each of the VMs 10. For instance, in the exemplary embodiment of FIG. 1, communication monitor 106A may count the number of network packets communicated through virtualized back-end interface 103A_{back} between VM 10₂ and net-IDD 20A, and communication monitor 106A may likewise count the number of network packets communicated through virtualized back-end interface 103A_{back} between VM 10_{N} and net-IDD 20A. In certain embodiments, CPU utilization monitor 107 may use the determined number of network packets for each of VM 10₂ and VM 10_{N} to determine a corresponding amount of CPU utilization of net-IDD 20A (e.g., device driver 104A) that is attributable to each of VM 10₂ and VM 10_{N}. Again, the monitored communications may be directed from the guest OS of a VM 10 to the appropriate virtualized interface of an IDD, as in a paravirtualized environment, or the monitored communications may be resource accesses from a guest OS that are intercepted by the VMM (and directed by the VMM through an appropriate virtualized interface), as in a non-paravirtualized environment (e.g., a fully-virtualized environment).

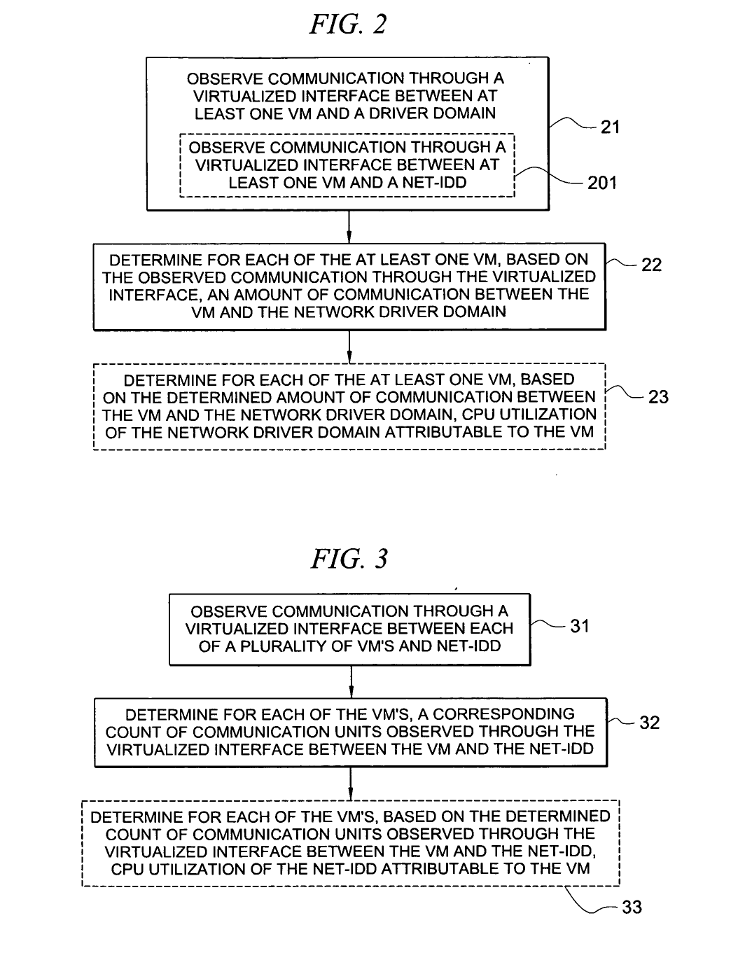

Turning to FIG. 2, an exemplary operational flow according to one embodiment of the present invention is shown. In operational block 21, a communication monitor (e.g., communication monitor 106A of FIG. 1) observes communication through a virtualized interface (e.g., virtualized back-end interface 103A_{back} of FIG. 1) between at least one VM (e.g., VM 10₂ and/or VM 10_{N} of FIG. 1) and a network driver domain. As shown in optional dashed-line block 201, in certain embodiments the network driver domain may be a net-IDD, as illustrated in FIG. 1. As described further herein, in certain embodiments the communication under observation are resource access requests from the VMs 10 to the network driver domain 20 for accessing the shared network resource whose device driver resides in such driver domain 20, such as network I/O requests. In operational block 22, the communication monitor determines for each of the VM(s), based at least on the observed communication through the virtualized interface, an amount of communication between the VM and the network driver domain.

As shown in optional dashed-line block 23, in certain embodiments a CPU utilization monitor (e.g., CPU utilization monitor 107 of FIG. 1) may determine for each of the VM(s), based on the determined amount of communication between the VM and the network driver domain, CPU utilization of the network driver domain that is attributable to the VM. Accordingly, by monitoring the communications from each of the VMs 10₂,. . . , 10_{N} through virtualized back-end interface 103A_{back} to the network driver domain 20A, for example, the CPU utilization monitor 107 is capable of attributing the corresponding amount of CPU utilization of the network driver domain 20A for servicing the communications (e.g., access requests) to the appropriate VMs 10₂, . . . , 10_{N} Thus, in certain embodiments an accurate accounting of the full CPU utilization of each VM 10 is provided by the CPU utilization monitor 107, wherein such accounting includes both the scheduled CPU utilization for each VM 10 and the corresponding amount of CPU utilization by the network driver domain 20 that is attributable to each VM 10. In certain embodiments, such as described further herein, the network driver domains 20 are isolated driver domains (i.e., net-IDDs).

FIG. 3 shows an exemplary operational flow according to another embodiment of the present invention. In operational block 31, a communication monitor (e.g., communication monitor 106A of FIG. 1) observes communication through a virtualized interface (e.g., virtualized back-end interface 103A_{back} of FIG. 1) between a plurality of VMs (e.g., VM 10₂ and VM 10_{N} of FIG. 1) and a net-IDD (e.g., net-IDD 20A of FIG. 1). In operational block 32, the communication monitor determines for each of the VMs, a corresponding count of communication units observed through the virtualized interface between the VM and the net-IDD. As shown in optional dashed-line block 33, in certain embodiments a CPU utilization monitor (e.g., CPU utilization monitor 107 of FIG. 1) may determine for each of the VMs, based on the determined count of communication units observed through the virtualized interface between the VM and the net-IDD, CPU utilization of the net-IDD that is attributable to the VM.

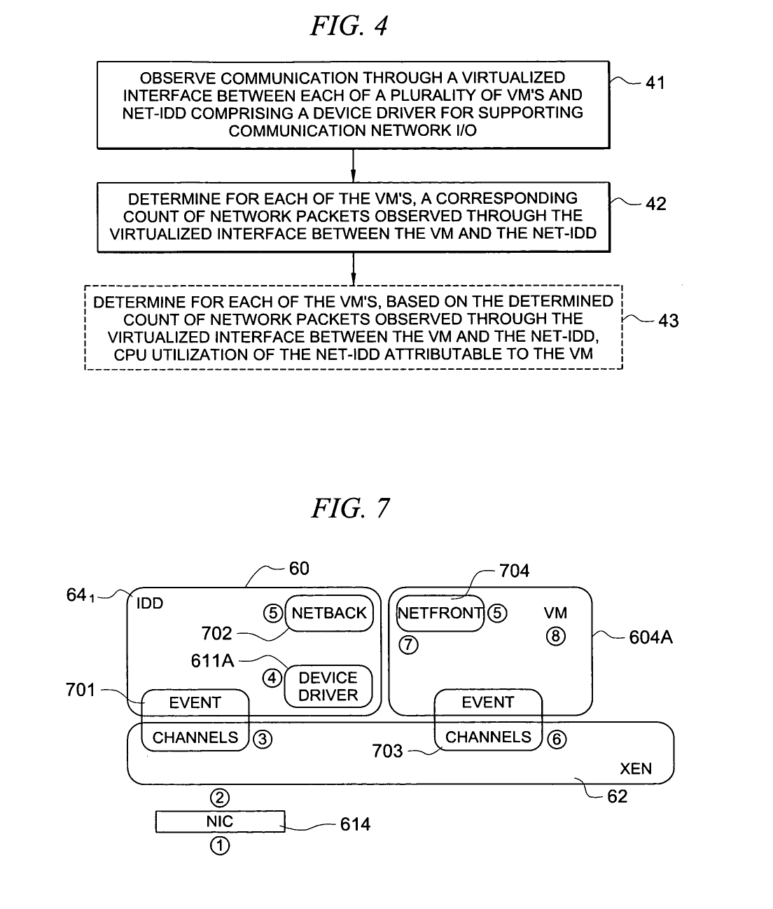

FIG. 4 shows an exemplary operational flow according to another embodiment of the present invention. In operational block 41, a communication monitor (e.g., communication monitor 106A of FIG. 1) observes communication through a virtualized interface (e.g., virtualized back-end interface 103A_{back} of FIG. 1) between each of a plurality of VMs (e.g., VM 10₂ and VM 10_{N} of FIG. 1) and a net-IDD (e.g., net-IDD 20A of FIG. 1) that comprises a device driver for supporting communication network I/O (e.g., device driver 104A of FIG. 1). In operational block 42, the communication monitor determines for each of the VMs, a corresponding count of network packets observed through the virtualized interface between the VM and the net-IDD. As shown in optional dashed-line block 43, in certain embodiments a CPU utilization monitor (e.g., CPU utilization monitor 107 of FIG. 1) may determine for each of the VMs, based on the determined count of network packets observed through the virtualized interface between the VM and the net-IDD, CPU utilization of the net-IDD that is attributable to the VM.

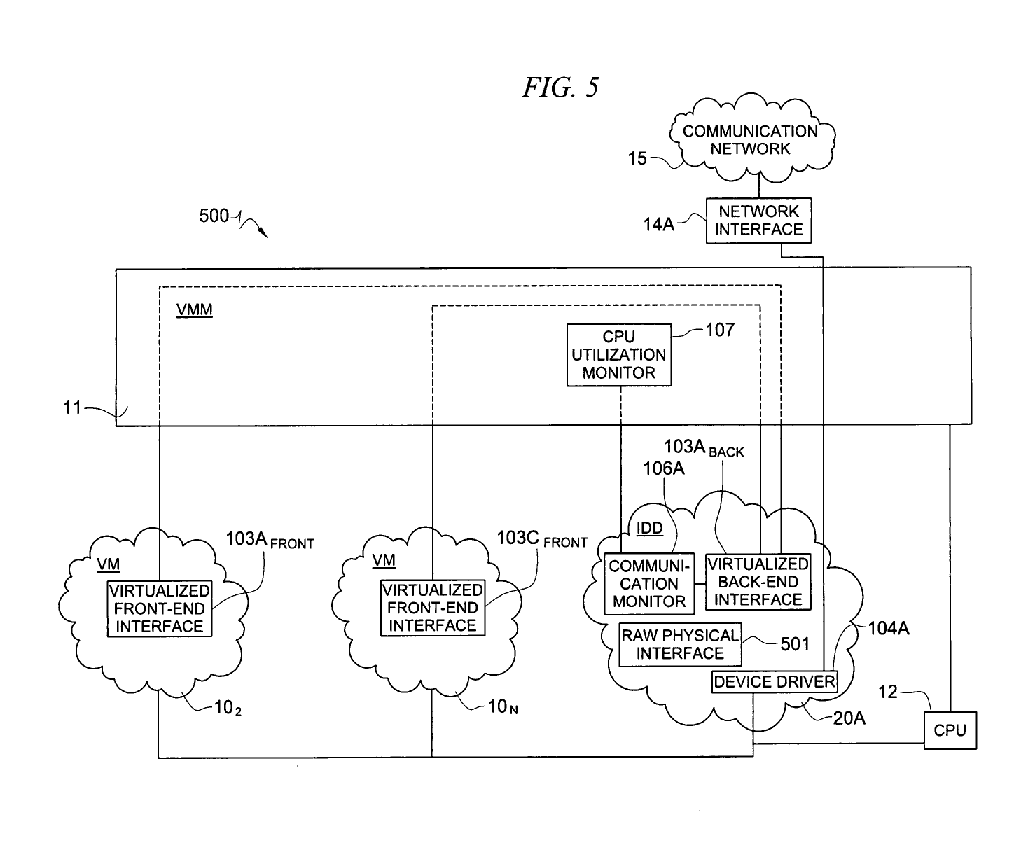

FIG. 5 shows an exemplary system 500 according to one embodiment of the present invention. As shown, functions in the back-end virtualized interfaces of IDDs are again provided for virtualizing the available resources of computer system 500 and multiplexing them among the various VMs 10₂ and 10_{N}. As with the example of FIG. 1, VMs 10₂ and 10_{N} are each requesting I/O access to network interface 14A via device driver 104A of net-IDD 20A through virtualized back-end interface 103A_{back}. As shown in this example, virtualized back-end interface 103A_{back} may serve as an intermediary between VMS 10₂ and 10_{N} and a raw physical interface 501 to the device driver 104A. As virtualized back-end interface 103A_{back} receives communication from one of the VMs directed to device driver 104A, it forwards the communication to the raw physical interface 501 of the device driver 104A. When the virtualized back-end interface 103A_{back} receives return communication from the device driver 104A (e.g., via the raw physical interface 501), the virtualized back-end interface 103A_{back} determines which of the VMs the return communication is intended for and directs such return communication to the intended VM (e.g., to the intended VM's virtualized front-end interface, such as virtualized front-end interface 103A_{front} of VM 10₂ or virtualized front-end interface 103C_{front} of VM 10_{N}). Thus, by monitoring the virtualized back-end interface 103A_{back}, communication monitor 106A is capable of determining the amount of communication between each of the VMS 10₂ and 10_{N} and device driver 104A. An exemplary embodiment of a virtualized interface that comprises a back-end interface referred to as “netback” and a front-end interface referred to as “netfront is described further below.

Exemplary techniques that may be employed by CPU utilization monitor 107 for determining the CPU utilization of a VM 10, including the amount of CPU utilization by the network driver domain 20 that is attributable to such VM 10, are described further below. As described further below, in certain embodiments, a light-weight monitoring technique is provided for measuring the CPU usage of different VMS 10, including the corresponding CPU overhead of the network driver domain 20 caused by processing (e.g., I/O processing) on behalf of a particular VM 10. This monitoring system can be used, as examples, for assistance in billing and/or for a whole variety of management tasks, such as: a) support of policy-based resource allocation; b) admission control of new VMS; c) support for VMS migration; and d) quality of service (“QoS”) provisioning of VMS.

Since the virtual machine technology allows different customers to share and utilize the same machine resources, the performance monitoring system provided herein, which accurately attributes the resource usage to different VMs, may be very important for certain management tasks. As one example, a virtual machine architecture, such as the exemplary Xen™ architecture described further below with FIGS. 6-7, may be used to create isolated virtual clusters out of existing machines in a data center that may be shared across different administrative units in an enterprise. Managing this virtual IT infrastructure and adapting to changing business needs presents a challenging task. In certain implementations of such virtual cluster system, virtual machines (VMs) can be migrated from one physical node to another when the current physical node capacity is insufficient, or for improving the overall performance of the underlying infrastructure. To support these management functions, an accurate monitoring infrastructure for reporting resource usage of different VMs becomes desirable. The CPU utilization monitor described herein may be advantageously employed for use in management of such a system, for example. Of course, embodiments of the CPU utilization monitor described herein may be employed for various types of applications (e.g., billing, resource utilization management, etc.) in any type of virtualized system that may be implemented, and thus is not limited in application to resource allocation management in the above-mentioned virtual cluster system.

Turning now to FIG. 6, an exemplary virtualization architecture implementing a CPU utilization monitor in accordance with one embodiment of the present invention is shown. More specifically, system 600 implements a known VMM architecture corresponding to that of Xen™ (which is referred to herein as Xen-3), which is a VMM developed for the x86 platform. Of course, such known VMM architecture is adapted to include the communication monitoring and CPU utilization monitoring functionality that is operable to attribute CPU utilization of a net-IDD to corresponding VMs, as described further below.

Exemplary system 600 includes a privileged management domain 60, referred to herein as “domain 0” (or “Dom₀”), which includes a guest OS (e.g., XenoLinux) 602 and one or more applications executing therein (e.g., control plane software) 601. System 600 further includes any number “N” of VMs or “domains” 61₁, . . . , 61_{N} implemented thereon (referred to collectively as VMs or domains 61). Within each VM 61, a guest OS is executing, such as guest OS 604A in VM 61₁ and guest OS 604B in VM 61_{N}. Further, one or more applications may be executing within each VM 61, such as application 603A in VM 61 and application 603B in VM 61_{N}. VMM 62 is implemented, which is a software layer that virtualizes the available resources of computer system 600 and multiplexes them among the various VMs 61.

Xen-3 62 is a virtual machine monitor for x86 based on a paravirtualization technique, which supports execution of multiple guest operating systems and does not require changes to the application binaries interfaces (ABI), and hence no modifications are required to guest applications. For more information concerning Xen-3, the reader is directed to K. Fraser, S. Hand, R. Neugebauer, I. Pratt, A. Warfield, M. Williamson, “Reconstructing I/O”, Tech. Report, UCAM-CL-TR-596, August 2004, the disclosure of which is hereby incorporated herein by reference. Xen-3 development is a result of a relatively new I/O virtualization model which adopts a different virtualization approach towards the I/O devices. Device drivers account for the majority of an operating system's code base, and the reuse of the existing driver infrastructure is a pragmatic requirement of any new OS project. The support of sufficiently wide variety of devices is a tremendous development effort for every OS project. New operating systems should benefit from the existing driver code base. One known and useful technique to reuse binaries drivers is via cohosting. In such an architecture, the processor is multiplexed between two collaborating operating systems with one providing device support.

In the initial design of Xen (see B. Dragovic, K. Fraser, S. Hand, T. Harris, A. Ho, I. Pratt, A. Warfield, P. Barham, and R. Neugebauer, “Xen and the Art of Virtualization,” In Proceedings of the ACM Symposium on Operating Systems Principles, October 2003), Xen itself contained device driver code and provided safe shared virtual device access. The later version of Xen, (Xen-2, see K. Fraser, et al., “Reconstructing I/O”, Tech. Report, UCAM-CL-TR-596, August 2004) allows unmodified device drivers to be hosted and executed in the privileged management domain: referred to as “Domain0” or “Dom₀”.

However, there are additional reasons for developing an alternative, more radical approach and architecture for reuse of legacy device drivers. Recent studies show that device drivers are frequently responsible for operating system failures. For example, a study from Stanford university found that the Linux drivers have 3 to 7 times the bug frequency as the rest of the OS. Similarly, product support calls for Windows 2000 showed that device drivers accounted for 27% of crashes compared to 2% for kernel support. Device drivers can be viewed as a type of kernel extensions, added after the fact. Commercial operating systems are typically extended by loading unsafe object code and linking it directly with the kernel.

To reduce the risk of device misbehavior and to address problems of dependability, maintainability, and manageability of I/O devices, Xen-3 uses the complete original OS itself as the compatibility wrapper for a device driver. The original OS effectively becomes an execution container for the driver. Thus, the exemplary system 600, includes isolated driver domains (“IDDs”) 64₁ , and 64₂, which include device drivers 611A and 611B respectively. In this implementation, the device drivers 611A and 611B run unmodified in privileged guest OSs 616A and 616B, respectively.

In the illustrated example, device driver 611A is a device driver supporting access to ethernet (“enet”) 614, and device driver 611B is a device driver supporting access to SCSI/IDE 615. Of course, application of the concepts presented herein are not limited to these exemplary device drivers, but rather additional and/or alternative device drivers may be implemented in isolated driver domains in alternative embodiments.

System 600 further includes various shared hardware resources 63. Use of the hardware resources 63 is shared by the various VMs 61, wherein VMM 62 manages access to such shared hardware resources 63 by the various VMs 61. Such shared hardware resources 63 include CPU 612, physical memory 613, network interface such as ethernet (“enet”) 614, and Small Computer System Interface (SCSI)/Integrated Drive Electronics (IDE) 615. VMM 62 virtualizes at least some of the shared resources, thus providing a virtual x86 CPU 607 and virtual physical memory 608. In addition to exporting virtualized instances of CPU and memory, VMM 62 exposes a control interface 606 to set how these resources are shared between the running domains 61.

This exemplary Xen virtualization architecture does not completely virtualize the underlying hardware. Instead, it adapts some parts of the hosted guest OSs, such as OSs 604A and 604B, to work with the VMM (or “hypervisor”) 62, and thus provides a paravirtualized architecture in which each guest OS is ported to a new target architecture, typically requiring changes in the machine-dependent code. For instance, each guest OS includes virtual device interfaces, such as virtual device interfaces 605A included in guest OS 604A of VM 61₁ and virtual device interfaces 605B included in guest OS 604B of VM 61_{N}, for communicating requests for access to certain shared hardware resources to the VMM 62 and/or through the VMM 62 to the IDDs 64₁ and 64₂. The user-level API of each VM is unchanged, allowing the existing binaries of applications, such as software applications 603A and 603B, to work unmodified.

The privileged management domain 60, “Domain 0,” is created at boot time and is permitted to use the control interface 606. The control interface 606 provides the ability to create and terminate other domains 61, control the CPU scheduling parameters and resource allocation policies, etc.

The exemplary virtualized system 600 of FIG. 6 is adapted in accordance with one embodiment of the present invention to include communication monitor(s) 106 and CPU utilization monitor 107. As described further herein, communication monitor(s) may be implemented to observe the amount of communication flowing through the virtualized interfaces between VMs 61 and the IDDs 64; and the CPU utilization monitor 107 is operable to, based on the amount of observed communication, determine a corresponding amount of CPU utilization of the IDDs 64 that is attributable to each of the VMs 61 (i.e., CPU utilization monitor 107 allocates the IDDs' CPU utilization among the various VMs 61 in a fair manner). In the specific example shown, a communication monitor 106 is implemented within net-IDD 64₁. Thus, in this example, the communication between the virtual device interfaces 605A, 605B of the guest OSs, and the device driver 611A that is implemented in the net-IDD 64₁ is monitored by communication monitor 106, whereby CPU utilization monitor 107 attributes CPU utilization of the net-IDD 64₁ to the corresponding VM 61 that caused such CPU utilization. Of course, communication monitors may similarly be implemented in other IDDs for monitoring the amount of communication flowing through the IDD's virtualized back-end interface.

Within the single host system 600 there are two levels of interface to a given resource: 1) at the lower level is the raw physical interface between the IDD (e.g., IDD 64₁) and the hardware device (resource), and 2) above this is the virtualized interface that is presented to the VMs 61 (e.g., virtualized interfaces 607-608). These two levels of interfaces, while being logically similar, need not be identical. The devices are shared between guest OSs, and there is only one “real” device driver for each device. To make the sharing work, IDD additionally includes a “back-end” driver for the hardware device it hosts. All unprivileged guest domains wishing to share the device include a “front-end” driver. Both of these drivers are virtual, they do not talk directly to hardware but are connected together using device channels. I/O data is transferred to and from each domain via the Xen-3 VMM 62, using shared-memory, asynchronous buffer descriptor rings.

FIG. 7 shows this I/O architecture of the exemplary Xen-3 embodiment of system 600 in more detail. This example illustrates the I/O processing path in Xen-3 for a networking application executing in a VM 604A for performing networking I/Os (e.g., via ethernet 614). The exemplary steps taken for processing an incoming network packet in this Xen-3 embodiment are numbered 1-8 in FIG. 7, and are described further hereafter. When the hardware (e.g., ethernet network interface 614) receives the packet (indicated by step number 1 in FIG. 7), it raises an interrupt that is trapped by the Xen-3 VMM 62 (indicated by step number 2 in FIG. 7). This additional level of control over the interrupt allows Xen to be more flexible in scheduling CPU across domains that these interrupts are destined for. Once Xen takes the interrupt, it determines which domain is responsible for the device and posts a virtual interrupt to the corresponding network driver domain (e.g., net-IDD 64₁ in FIG. 6) via the event channel 701 (as indicated by step number 3 in FIG. 7). When the network driver domain is scheduled next, it sees a pending interrupt for it and invokes the appropriate interrupt handler.

The interrupt handler in the network driver domain only serves to remove the packet from the real device driver 611 A (as indicated by step number 4 in FIG. 7) and hand it over to the “back-end” driver 702 (as indicated by step number 5 in FIG. 7). In FIG. 7, the “back end” driver 702 is denoted as “netback.” Note that no TCP/IP protocol processing is involved in this step 5 (except perhaps the inspection of the IP header).

It is the back-end driver 702's job to forward the packet to the correct “front-end” driver 704, denoted “netfront” in FIG. 7. This forwarding takes place in two stages. In the first stage, the network driver domain (e.g., net-IDD 64₁ of FIG. 6) posts a “virtual interrupt” to the target guest domain 604A, via event channels 703. When the target guest domain 604A is next scheduled, it will see that it has an interrupt pending. To get the actual data from the network driver domain 64₁, in this second stage, the guest domain 604A then initiates a “memory page exchange” (as indicated by step number 6 in FIG. 7), for the memory page containing the packet that it will receive from the network driver domain. Note that this operation does not involve copying any packet data. Packets are stored in a shared memory region, and during the second stage above, the ownership of the memory page containing packet data is flipped from the network driver domain 64₁ to the guest domain 604A. Finally, the packet reaches the “virtual” device driver “netfront” 704 in the guest domain 604A (as indicated by step number 7 in FIG. 7) and is then passed onto higher layers of the TCP/IP stack for further processing (as indicated by step number 8 in FIG. 7). It should be noted that in this exemplary architecture, the netback virtual driver 702 is an ideal observation point because all of the packets (both on the send and receive paths between the network driver domain and the guest domain) should pass through such netback 702. As described further herein, netback 702 may be instrumented to provide detailed measurements on the number of packets processed by such netback 702 (i.e., corresponding IDD) in both directions per each guest domain.

The above description of the Xen-3 virtualization architecture and communication model of FIGS. 6 and 7 are intended merely as an example of a known virtualization architecture in which embodiments of the present invention may be employed. Thus, the above-described Xen-3 virtualization architecture of FIGS. 6 and 7 are known in the art, and embodiments of a communication monitor(s) 103 and/or CPU utilization monitor 107 may be employed in such virtualization architecture in the manner described further below. Of course, embodiments of the present invention are not limited to application within the above-described exemplary virtualization architecture. Rather, embodiments of the present invention for attributing to corresponding VMs CPU utilization of an IDD (e.g., driver domain 64₁ or 64₂) in which a shared resource's device driver resides may be employed in any virtualization architecture. Further, embodiments of the present invention may be employed within a virtualization architecture that uses any communication scheme between the VMs and the IDD for accessing a shared resource.

An exemplary method for accurately partitioning the CPU overhead in a driver domain containing a network device driver (referred to herein as a net-IDD), such as net-IDD 64₁ of FIG. 6, across corresponding VMs according to one embodiment of the present invention is now described. This exemplary method is based on a per-VM packet counter that reflects a number of packets, both received and sent by the net-IDD, on behalf of particular VM per time unit. Such a per-VM packet counter may be implemented, for example, by communication monitor 106A of FIG. 1 or by communication monitor(s) 106 of FIG. 6. This per-VM packet counter is used (e.g., by CPU utilization monitor 107) to partition the CPU overhead in net-IDD across corresponding VMs.

To further describe this exemplary embodiment, let Dom₀, Dom₁, . . . , Domₖ be virtual machines that share the host node, where Dom₀ is a privileged management domain (Domain0), such as Dom₀ 60 of FIG. 6. Let Dom_{idle} denote a special idle domain that “executes” on the CPU when there are no other runnable domains (i.e. there is no virtual machine that is not blocked and not idle). Dom_{idle} is the analog to the “idle-loop process” executed by an OS when there are no other runnable processes. Further, let IDD₁, . . . , IDDₘ be isolated driver domains (privileged virtual machines) each hosting the driver for different network devices, referred to herein as a net-IDD, such as IDD 64₁ of FIG. 6.

The traditional monitoring system, that can be found in VMware's and other commercial products, typically measures the amount of CPU allocated by the scheduler for an execution of the particular VM over time. This is a relatively straightforward approach which employs instrumentation of the CPU scheduler in the VMM (or “hypervisor”). Such an instrumentation generally results in the following CPU usage recording (referred to as “equation (1)”:

(Domᵢ_{₁}, t₁, t₂) (IDDᵢ_{₂}, t₃, t₄),(Domᵢ_{₃},t₅,t₆),(Dom_{idle}, t₉,t₁₀), . . . ,(IDDᵢ_{ⱼ},tⱼ,tⱼ₊₁),(Domᵢ_{ₖ}, tₙ₋₁,tₙ), where the tuple (Domᵢ_{ₖ},tₙ₋₁, tₙ) means that virtual machine Domᵢ_{ₖ} was using CPU starting at time tₙ₋₁ and ending at time tₙ, and similarly (IDDᵢ_{ⱼ},tⱼ,tⱼ₊₁), means that isolated driver domain IDDᵢ_{ⱼ} was using CPU starting at time tⱼ and ending at time tⱼ₊₁.

A more convenient and detailed data structure may be employed that provides a similar functionality and keeps such information per each guest domain Domᵢ(or IDDᵢ), and indicates the state of the domain. At any point of time, guest domain Domᵢ(or IDDᵢ) can be in one of the following three states:

1) execution state: domain Domᵢ(or IDDᵢ) is currently using CPU;

2) runnable state: domain Domᵢ(or IDDᵢ) is not currently using CPU but is in the run queue and waiting to be scheduled for execution on the CPU; and

3) blocked state: domain Domᵢ(or IDDᵢ) is blocked and is not in the run queue (once unblocked it is put back in the run queue).

For each domain Domᵢ(or IDDᵢ), a sequence of data describing the timing of domain state changes is collected according to the following (“equation (2)”):

Domᵢ:(t₁ⁱ, t₂ⁱ,executions),(t₂ⁱ,t₃ⁱ,runnable),(t₅ⁱ,t₆ ⁱ,executions),(t₆ⁱ,t₇ⁱ,blocked),(t₇ⁱ,t₈ⁱ,runnable), . . . .

By having such a data structure, a share of CPU which was allocated to Domᵢ (or IDDᵢ) over time T=(T₁,T₂) can be easily computed as follows (“equation (3)”):

$$CPU ( {Dom}_{i} , T ) = \frac{{\sum }_{{Ex}_{j}^{i} ∈ ( {T}_{1} , {T}_{2} )} CPU ( {Dom}_{i} , {Ex}_{j}^{i} )}{{T}_{2} - {T}_{1}} ,$$

where execution period Exⱼⁱ=(tⱼⁱ,tⱼ₊₁ⁱ,execution) denotes the time period (tⁱⱼ,tⱼ₊₁ⁱ) with Domᵢ being in the execution state.

According to one embodiment, within the monitoring system (e.g., within CPU utilization monitor 107), we use time interval T=100 milliseconds (ms) to aggregate overall CPU usage across different VMs, i.e. T₂−T₁+100 ms. Of course, time unit T=100 ms can be set to any other time interval that may be desired in other embodiments. Thus, the CPU usage can be computed by IDD₁, . . . , IDDₘ, Dom₀, Dom₁, . . . , Domₖ and Dom_{idle} over any time interval.

In addition to computing CPU usage by IDD₁, . . . ,IDDₘ, this exemplary embodiment uses additional instrumentation (e.g., communication monitor 103A) employed in the netback virtual driver 702 for each IDDᵢ that provides information on the overall number of packets processed by IDDᵢ on behalf of Domᵢ, wherein 0≦l≦k.

Thus, for each execution state Exⱼⁱ=(tⱼⁱ,tⱼ₊₁ⁱ, execution) of IDDᵢ, there may be a number of packets both sent and received between IDDᵢ and Domᵢ as measured in the netback virtual driver 702 in IDDᵢ that is denoted as a packet counter Packs(IDDᵢ, Domₗ, Exⱼⁱ). According to this exemplary embodiment, we also keep track of the overall number of packets both sent and received by IDDᵢ in each execution state Exⱼⁱ for/from all guest domains according to the following (“equation (4)”):

$$Packs ( {IDD}_{i} , {Ex}_{j}^{i} ) = {\sum }_{1 \leq l}^{l \leq k} Packs ( {IDD}_{i} , {Dom}_{l} , {Ex}_{j}^{i} ) .$$

By having such a data structure, it is easy to compute a number of packets both sent and received between IDDᵢ and Domₗ over time T=(T₁, T₂) according to the following (“equation (5)”):

$$Packs ( {IDD}_{i} , {Dom}_{l} , T ) = {\sum }_{{Ex}_{j}^{i} ∈ ( {T}_{i} , {T}_{2} )} Packs ( {IDD}_{i} , {Dom}_{l} , {Ex}_{j}^{i} ) .$$

Thus, Packs(IDDᵢ, Domᵢ, T) reflects a value of packet counter per virtual machine Domₗ during time interval T in IDDᵢ. According to this exemplary embodiment, the communication monitor also observes the overall number of packets both sent and received by IDDᵢ over time T=(T₁, T₂) as follows (“equation (6)”):

$$Packs ( {IDD}_{i} , T ) = {\sum }_{{Ex}_{j}^{i} ∈ ( {T}_{i} , {T}_{2} )} Packs ( {IDD}_{i} , {Ex}_{j}^{i} ) .$$

According to one embodiment, the CPU utilization monitor 107 partitions the CPU overhead in the net-IDD across corresponding VMs. To do this, in one embodiment, CPU utilization monitor 107 uses a ratio of packet counter per virtual machine with respect to overall packets observed in this time interval. For example, the partitioning packet ratio PacksRatio for the CPU overhead in net-IDD on behalf of domain Domᵢ may be computed in the following way (“equation (7)”):

$$PacksRatio ( {IDD}_{i} , {Dom}_{l} , T ) = \frac{Packs ( {IDD}_{i} , {Dom}_{l} , T )}{Packs ( {IDD}_{i} , T )} .$$

### A share of CPU time used by IDDᵢ for processing the I/O related activities on behalf of Domₗ over time T=(T₁,T₂) may be computed according to the following (“equation (8)”):

CPU(IDDᵢ,Domₗ,T)=CPU(IDDᵢ,T)×PacksRatio(IDDᵢ,Domₗ,T).

As mentioned above, within the monitoring system (e.g., CPU utilization monitor 107), a time interval of 100 ms may be used to aggregate overall CPU usage across different virtual machines, but this time unit T=100 ms can be set to a different time interval if so desired.

The above exemplary data structures and equations may be employed by, for example, a communication monitor (e.g., communication monitor 106A of FIG. 1) and/or a CPU utilization monitor (e.g., CPU utilization monitor 107 of FIG. 1). When implemented via computer-executable instructions, various elements of embodiments of the present invention are in essence the software code defining the operations of such various elements. The executable instructions or software code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media can include any medium that can store or transfer information. In certain embodiments, a CPU may execute the various logical instructions according to embodiments of the present invention. For example, a CPU may execute machine-level instructions according to the exemplary operational flows described above in conjunction with FIGS. 2-4 and/or according to the above-described data structures and equations.

It shall be appreciated that the present invention is not limited to the architecture of the system on embodiments thereof may be implemented. For example, any suitable processor-based device may be utilized for implementing the above-described operations, including without limitation personal computers, laptop computers, computer workstations, and multi-processor servers. Moreover, embodiments of the present invention may be implemented on application specific integrated circuits (ASICs) or very large scale integrated (VLSI) circuits. In fact, persons of ordinary skill in the art may utilize any number of suitable structures capable of executing logical operations according to the embodiments of the present invention.

What is claimed is:

1. A method comprising:
observing communication through a virtualized interface between at least one virtual machine (VM) and a driver domain; and
determining for each of the at least one VM, based on the observed communication through the virtualized interface, an amount of communication between the VM and the driver domain.

2. The method of claim 1 further comprising:
determining for each of the at least one VM, based on the determined amount of communication between the VM and the driver domain, CPU utilization of the driver domain attributable to the VM.

3. The method of claim 1 wherein the driver domain comprises an isolated driver domain (IDD).

4. The method of claim 3 wherein the IDD comprises a device driver for network communication.

5. The method of claim 4 wherein the determining comprises:
determining for each of the at least one VM, based on the observed communication through the virtualized interface, a number of network packets communicated through the virtualized interface between the VM and the IDD.

6. The method of claim 1 comprising:
a plurality of virtual machines (VMs) communicating with an isolated network driver domain (net-IDD) for accessing a communication network, wherein a device driver for the communication network resides in the net-IDD.

7. The method of claim 6 further comprising:
determining CPU utilization of each of the plurality of VMs, based at least in part on determined CPU utilization of the net-IDD attributable to each of the VMs.

8. The method of claim 6 further comprising:
determining, for each of the plurality of VMs, a corresponding amount of CPU utilization by the net-IDD that is attributable to the VM based at least in part on a number of network packets communicated through the virtualized interface between the VM and the net-IDD.

9. The method of claim 1 further comprising:
determining a share of CPU time used by an isolated driver domain (IDDᵢ) for processing input/output (I/O)-related activities on behalf of a virtual machine (Domₗ) over time T=(T₁,T₂) as: CPU(IDDᵢ,Domₗ,T)=CPU(IDDᵢ,T)×PacksRatio(IDDᵢ,Domₗ,T), wherein PacksRatio(IDDᵢ, Domₗ, T) is computed as:
$$PacksRatio ( {IDD}_{i} , {Dom}_{l} , T ) = \frac{Packs ( {IDD}_{i} , {Dom}_{l} , T )}{Packs ( {IDD}_{i} , T )} ,$$
wherein Packs(IDDᵢ, Domₗ, T) reflects a number of packets communicated through the virtualized back-end interface between virtual machine Domₗ and IDDᵢ over time T and wherein Packs(IDDᵢ, T) reflects a total number of packets communicated through the virtualized back-end interface between all virtual machines and IDDᵢ over time T.

10. Computer-executable software code stored to a computer-readable medium, the computer-executable software code comprising:
code for counting, for each of a plurality of virtual machines (VMs), a corresponding number of communication units communicated through a virtualized interface between the VM and a network driver domain;
code for determining, for each of the plurality of VMs, a corresponding amount of CPU utilization by the net-IDD that is attributable to the VM based at least in part on a number of network packets communicated through the virtualized interface between the VM and the net-IDD.

11. The computer-executable software code of claim 10 further comprising:
code for determining, for each of the plurality of VMs, a corresponding total CPU utilization of the VM based at least in part on the determined corresponding amount of CPU utilization by the net-IDD that is attributable to the VM.

12. The computer-executable software code of claim 11 wherein the code for determining, for each of the plurality of VMs, a corresponding total CPU utilization of the VM is further based on a corresponding amount of CPU utilization used directly by the VM.

13. The computer-executable software code of claim 11 further comprising:
code for taking an action in response to the determined corresponding total CPU utilization of the VM.

14. The computer-executable software code of claim 11 further comprising:
code for managing the plurality of VMs based at least in part on their respective total CPU utilization.

15. A system comprising:
Central Processing Unit (CPU);
Virtual Machines (VMs);
at least one isolated network driver domain (net-IDD) in which a device driver for communicatively accessing a communication network resides;
a virtualized back-end interface for the net-IDD through which network packets between the VMs and the device driver flow; and
a CPU utilization monitor operable to determine, based at least in part on a number of network packets communicated through the virtualized back-end interface between the net-IDD and a given VM, an amount of CPU utilization of the net-IDD that is attributable to the given VM.

16. The system of claim 15 further comprising:
a virtual machine monitor (VMM), wherein said CPU utilization monitor is implemented in said VMM.

17. The system of claim 15 wherein each of the VMs comprises a virtualized front-end interface communicatively coupled to the virtualized back-end interface.

18. The system of claim 15 wherein the virtualized back-end interface is implemented in the net-IDD.

19. The system of claim 15 further comprising:
a communication monitor that observes the number of network packets communicated through the virtualized back-end interface between the net-IDD and the given VM and communicates the observed number of network packets to the CPU utilization monitor.

20. The system of claim 15 wherein the virtualized back-end interface determines which of the VMs received network packets from the net-IDD is to be directed.
